(19) United States
(12) Patent Application Publication
(10) Pub. No.: US 2019/0103669 A1
(43) Pub. Date: Apr. 4, 2019

(54) COMMUNICATION APPARATUS, METHOD FOR CONTROLLING COMMUNICATION APPARATUS, AND STORAGE MEDIUM STORING PROGRAM

(71) Applicant: Canon Kabushiki Kaisha, Tokyo (JP)

(72) Inventor: Yasuaki Ise, Yokohama-shi (JP)

(21) Appl. No.: 16/135,615

(22) Filed: Sep. 19, 2018

(30) Foreign Application Priority Data
Sep. 29, 2017 (JP) 2017-190805

(51) Int. Cl. H01Q 3/08; H01Q 3/26; H01Q 3/36; G01S 5/24; H04B 7/26

(52) U.S. Cl. CPC H01Q 3/08; H01Q 3/2605; H04B 7/2609; G01S 5/24; H01Q 3/36

(57) ABSTRACT

A communication apparatus that performs wireless communication by directional communication includes a detection unit that detects a change in a position of the communication apparatus, and a control unit that controls changing a communication direction for performing the directional communication between the communication apparatus and another communication apparatus based on the detected change in the position of the communication apparatus.

### BACKGROUND

### Field

The present disclosure relates to a communication apparatus, a method for controlling a communication apparatus, and a storage medium storing a program.

### Description of the Related Art

In recent years, there has been a growing demand for further high-speed data communication to, for example, transmit and receive uncompressed moving image data. Attempts to meet this demand have led to, for example, attention paid to communication using a millimeter-wave band, which has made broadband communication available, and formulation of standard specifications such as the Institute of Electrical and Electronics Engineers (IEEE) 802.15.3c standard and the IEEE 802.11ad standard. Regarding the millimeter-wave band, a broad bandwidth is permitted to be used for signal transmission. Thus, the millimeter-wave band is effectively employable for the high-speed communication.

In a communication system using a frequency having a strong property of traveling in a straight line like the millimeter-wave band, directionality is controlled using an array antenna to improve communication sensitivity. When directional communication is performed on a mobile terminal, the communication is affected by a communication direction based on a movement and a rotation of the mobile terminal. A failure to control the antenna in an optimum direction can impair stability of wireless communication, which makes the communication difficult. To address such an issue, Japanese Patent Application Laid-Open No. 2014-53780 discusses a communication device including a calculation section that calculates a change in a direction of the communication device, and a trigger control section that controls an update trigger for a beam pattern of an adaptive array antenna based on the calculated change.

The communication device discussed in Japanese Patent Application Laid-Open No. 2014-53780 has an issue of failing to take a change in a position of the communication device into consideration. Therefore, the communication device discussed in Japanese Patent Application Laid-Open No. 2014-53780 may be unable to maintain the directional communication when the position of the communication device is unexpectedly changed due to, for example, a movement of the communication device, which leads to failure of stabilization of the directional communication.

### SUMMARY

According to an aspect of the present disclosure, a communication apparatus that performs wireless communication by directional communication includes a detection unit configured to detect a change in a position of the communication apparatus and a control unit configured to control changing a communication direction for performing the directional communication between the communication apparatus and another communication apparatus based on the detected change in the position of the communication apparatus.

Further features will become apparent from the following description of exemplary embodiments (with reference to the attached drawings).

### BRIEF DESCRIPTION OF THE DRAWINGS

FIG. 1 is a schematic view illustrating a configuration of a wireless communication system.

FIGS. 2A and 2B are diagrams illustrating a configuration of a directional communication unit.

FIG. 3 is a timing chart illustrating an operation of a wireless communication unit.

FIG. 4 (FIGS. 4A to 4F) are diagrams each illustrating an operation of a mapping processing unit.

FIG. 5 is a sequence diagram illustrating processing performed by a transmission apparatus.

FIGS. 6A and 6B are diagrams each illustrating a method by which the mapping processing unit updates a position.

FIGS. 7A to 7G are a conceptual diagram each illustrating a transmission direction and a directionality width of a directional transmission antenna.

FIG. 8 is a flowchart illustrating processing performed by the transmission apparatus.

FIGS. 9A to 9I are diagrams each illustrating an operation of changing a transmission/reception direction.

FIGS. 10A to 10D are diagrams illustrating an operation of conducting a transmission/reception direction search.

FIGS. 11A and 11B are diagrams illustrating a configuration of an imaging unit.

### DESCRIPTION OF THE EMBODIMENTS

In the following description, representative exemplary embodiments will be described in detail with reference to the drawings.

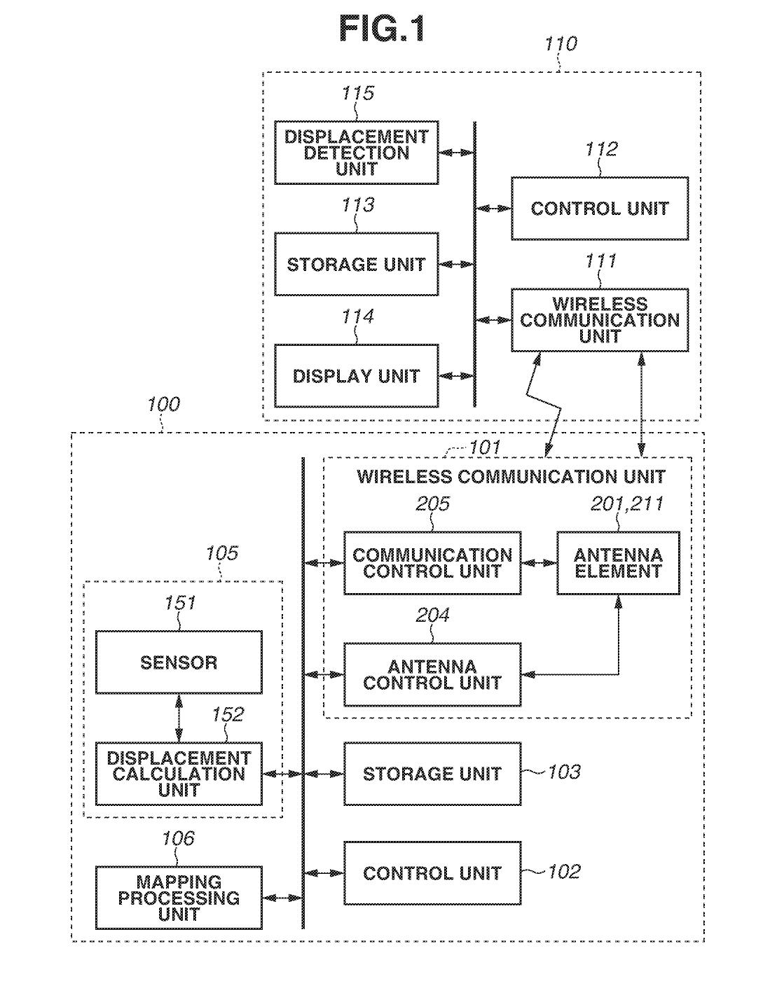

FIG. 1 is a schematic view illustrating an example of a configuration of a wireless communication system according to the present exemplary embodiments.

The wireless communication system includes a transmission apparatus 100, such as a camera (an imaging apparatus), as a first communication apparatus, and a reception apparatus 110, such as a tablet terminal, as a second communication apparatus. Each of the transmission apparatus 100 and the reception apparatus 110 can perform wireless communication. The transmission apparatus 100 can also receive information from the reception apparatus 110, and the reception apparatus 110 can also transmit information to the transmission apparatus 100.

The transmission apparatus 100 includes a wireless communication unit 101, a control unit 102, a storage unit 103, a displacement detection unit 105, and a mapping processing unit 106. The displacement detection unit 105 and the mapping processing unit 106 can be included in a part of the control unit 102.

The control unit 102 is in charge of control of the entire transmission apparatus 100. The control unit 102 is, for example, a central processing unit (CPU) or a micro processing unit (MPU).

The storage unit 103 stores various kinds of data therein. The storage unit 103 includes, for example, a nonvolatile memory and a random access memory (RAM). The nonvolatile memory stores therein a processing procedure (a program) executed by the control unit 102, various kinds of settings of the transmission apparatus 100, a graphical user interface (GUI) data, such as a menu screen, and the like. The RAM is used as a work area of the control unit 102.

The displacement detection unit 105 detects a change in a position and a change in an orientation of the transmission apparatus 100. The displacement detection unit 105 corresponds to one example of a detection unit. The displacement detection unit 105 includes a sensor 151 and a displacement calculation unit 152. The sensor 151 is, for example, a six-axis acceleration sensor. The sensor 151 detects accelerations in x, y, and z directions, and angular accelerations of a roll, a pitch, and a yaw. The sensor 151 detects the accelerations when the position and the orientation of the transmission apparatus 100 are changed, and outputs the detected accelerations to the displacement calculation unit 152 as detection information.

The displacement calculation unit 152 calculates the change in the position and the change in the orientation of the transmission apparatus 100 from the accelerations detected by the sensor 151. For example, the displacement calculation unit 152 calculates a speed and a change amount from a preset reference position and reference orientation by integrating the accelerations detected by the sensor 151 over time while setting an initial orientation of the transmission apparatus 100 when the communication is started as the reference position and the reference orientation.

The sensor 151 is not limited to the six-axis acceleration sensor. For example, the sensor 151 may be a combination of a gravity sensor and a three-axis acceleration sensor, and the change in the position and the change in the orientation may be detected by detecting a direction of gravitational force by the gravity sensor and integrating over time the accelerations in the x, y, and z directions that are detected by the three-axis acceleration sensor. Alternatively, the sensor 151 may be a combination of, for example, a multi-axis acceleration sensor and a multi-axis gyro sensor or a geomagnetic sensor, and the change in the position and the change in the orientation may be detected thereby. The change amount can also be calculated by detecting rotational angle information from a gyro sensor and integrating it. Alternatively, in a case where the transmission apparatus 100 includes an imaging unit, the change in the position and the change in the orientation of the transmission apparatus 100 may be detected from a captured image. Further alternatively, the sensor 151 may be formed by a combination of another orientation detection sensor and a position detection sensor such as a global positioning system (GPS).

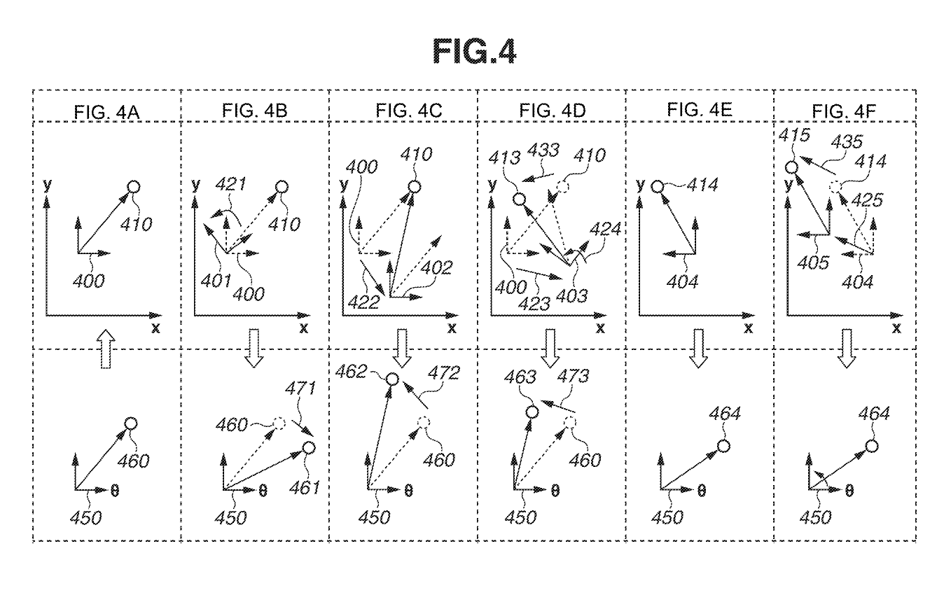

The mapping processing unit 106 maps a relative position of the transmission apparatus 100 from the reference position. The mapping processing unit 106 sets a reference point based on an instruction from the control unit 102, and maps a three-dimensional position from the reference point (a reference coordinate system) and tracks the change in the position and the change in the orientation. The change in the position and the change in the orientation are tracked by integrating the change from the reference position and drawing a track thereof. Therefore, as illustrated in FIG. 4 (FIGS. 4A to 4F), which will be described below, the mapping processing unit 106 can map the positions and the changes of the transmission apparatus 100 and the reception apparatus 110 in the reference coordinate system. Further, the mapping processing unit 106 can map a relative position between the transmission apparatus 100 and the reception apparatus 110 in an antenna coordinate system viewed from a direction where an antenna of the transmission apparatus 100 is installed.

The reception apparatus 110 includes a wireless communication unit 111, a control unit 112, a storage unit 113, a display unit 114, and a displacement detection unit 115.

The control unit 112 is in charge of control of the whole of the reception apparatus 110. The control unit 112 is, for example, a CPU or an MPU.

The storage unit 113 stores various kinds of data therein. The storage unit 113 includes, for example, a nonvolatile memory and a RAM. The nonvolatile memory stores therein a processing procedure (a program) executed by the control unit 112, various kinds of settings of the reception apparatus 110, a GUI data such as a menu screen, and the like. The RAM is used as a work area of the control unit 112. A video signal received by the control unit 112 is decoded, and is stored into the storage unit 113 or directly displayed on the display unit 114.

The reception apparatus 110 is not limited to being the tablet terminal, and may be a video projection apparatus such, as a notebook personal computer (PC), a television, and a projector, or a portable electronic apparatus, such as a digital camera and a smart-phone.

The wireless communication units 101 and 111 each include a directional communication unit and a non-directional communication unit.

The non-directional communication unit has a wireless communication function in compliance with a wireless communication standard, such as Wireless Fidelity (WiFi®) and Bluetooth®, and wirelessly communicates with an external apparatus in a wireless communication network.

The directional communication unit performs directional wireless communication using a millimeter-wave band, such as the IEEE 802.15.3c standard and the IEEE 802.11ad standard. The directional communication achieves a high communication rate compared to the non-directional communication, but the communication rate thereof may undesirably extremely reduce when a communication route is blocked by an obstacle or the like.

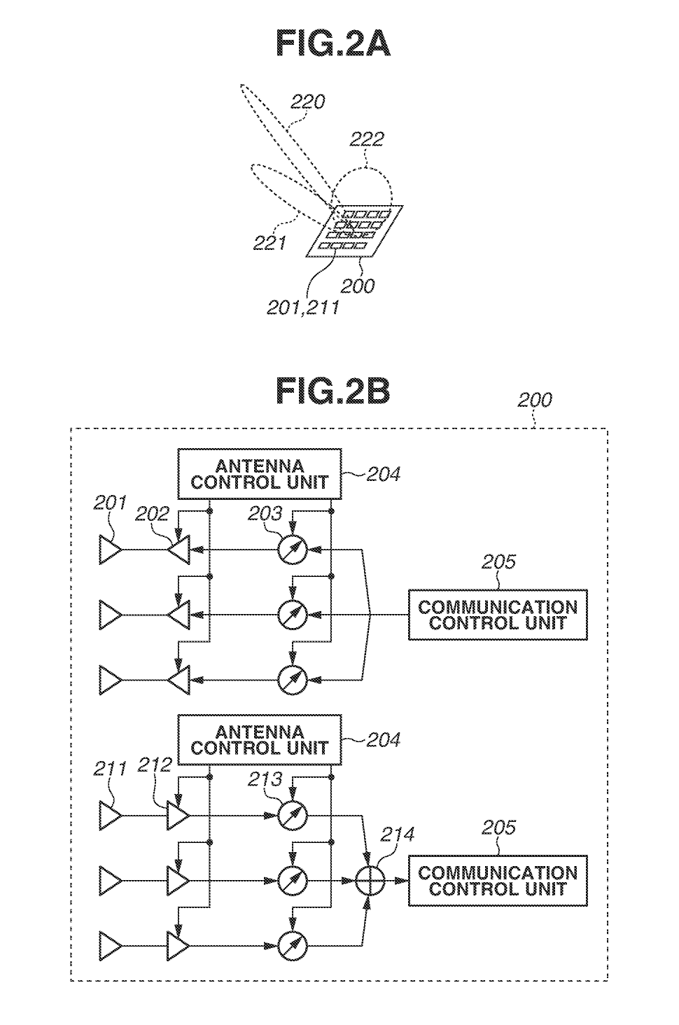

FIGS. 2A and 2B are diagrams illustrating an example of a configuration of the directional communication unit in the wireless communication unit 101 or 111.

A chip antenna module 200 can be used as the directional communication unit. Further, an antenna array module can be employed as the chip antenna module 200. As illustrated in FIG. 2A, a plurality of antenna elements 201 of a directional transmission antenna, and a plurality of antenna elements 211 of a directional reception antenna are arrayed in the chip antenna module 200.

As illustrated in FIG. 2B, the directional communication unit further includes a communication control unit 205, an antenna control unit 204, and the like. Further, the directional communication unit may include a memory or the like. The control unit 102 generates a control signal for controlling the antenna elements 201 and 211. The directional communication unit is not limited to the configuration including the directional transmission antenna and the directional reception antenna separately, and may include one antenna shared for both functions and be formed by one directional transmission and reception antenna.

On the directional transmission antenna side, when a transmission signal is input from the communication control unit 205, the transmission signal is distributed and input to a phase shifter 203. The transmission signal is radiated via the directional transmission antenna (the antenna elements 201) via an amplifier 202 after being subjected to an arbitrary phase shift by the phase shifter 203. An amount of the phase shift and an amount of the amplification can be changed by the control unit 102 changing the control signal directed to the antenna control unit 204. Therefore, a direction in which radio waves are radiated, and a transmission antenna pattern such as narrow directionality or wide directionality can be controlled.

On the directional reception antenna side, a signal propagated in a free space is received by the directional reception antenna (the antenna elements 211). The received signal is subjected to a phase shift by a phase shifter 213 and added by an adder 214 after being amplified by an amplifier 212. The signal after the addition is output from the communication control unit 205 as a reception signal. An amount of the phase shift and an amount of the amplification applied to the reception signal can be changed by the control unit 102 changing the control signal directed to the antenna control unit 204. Therefore, a reception direction, and a reception antenna pattern, such as narrow directionality or wide directionality, can be controlled.

FIG. 2A illustrates an example when the transmission direction is changed by the directional transmission antenna. Hereinafter, in the present exemplary embodiment, the transmission direction refers to a transmission directional direction of the directional transmission antenna that the transmission apparatus 100 uses at the time of the transmission, and the reception direction refers to a reception directional direction of the directional reception antenna that the reception apparatus 110 uses at the time of the reception. Further, in the present exemplary embodiment, when the transmission direction and the reception direction do not have to be distinguished from each other, they are expressed as a transmission/reception direction.

Generally, reducing the directionality can earn a communication strength according to the number of antenna elements with respect to the transmission direction. Accordingly, a communication distance is increased. On the other hand, realizing the wide directionality leads to a reduction in the number of allocated antenna elements with respect to one transmission direction. Accordingly, the communication strength is reduced and the communication distance is reduced. Therefore, in an order of transmission directions 222, 221, and 220 illustrated in FIG. 2A, the directionality reduces and the communication distance increases. Further, when the reception direction does not match a direction from which the signal propagated in the free space arrives, the individual directional reception antennas are out of phase with each other. Accordingly, undesirable interference occurs between signals out of phase with each other, which results in insufficient sensitivity. Therefore, generally, the reception sensitivity is lowered by widening the reception direction of the antenna elements, and a signal intensity when the signal is received can be enhanced by narrowing the reception direction of the antenna elements, with respect to the direction from which the signal arrives, similarly to the transmission direction.

The control unit 102 may organize, into a matrix, a relationship of the phase shift amount directed to each of the phase shifters 203 and 213 and an amplification factor directed to each of the amplifiers 202 and 212 with the transmission/reception direction, and calculate them each time. Alternatively, the control unit 102 may store a setting content according to the transmission/reception direction and a directionality width (a signal width) in the storage unit 103 as a lookup table (LUT). The control unit 102 can notify the antenna control unit 204 of the setting value read out from the LUT according to the determined transmission/reception direction and directionality width.

Further, the control unit 102 may have a function as a distance measurement unit that measures a distance between the transmission apparatus 100 and the reception apparatus 110. For example, a function such as the Frequency Modulated Continuous Wave (FMCW) method, which is used in an in-vehicle millimeter-wave radar, can be used. Alternatively, for example, the chip antenna module 200 includes a not-illustrated mixer and coupler, and generates a transmission wave by applying frequency modulation (FM) of a triangular wave to an oscillator and transmits the transmission wave from the antenna to the reception apparatus 110 which is a target. The chip antenna module 200 distributes a part of the transmission wave by the not-illustrated coupler and mixes it with a reception wave by the mixer. The transmission wave delivered to the reception apparatus 110 is reflected by the reception apparatus 110 to generate a reflection wave and is received as the reception wave, and then is mixed with the transmission wave by a reception mixer after that, from which a beat signal is generated. The distance to the reception apparatus 110 may be calculated by calculating a fast Fourier transform (FFT) of this beat signal and performing a predetermined calculation and analysis thereon. The detection of the position of the reception apparatus 110 or the distance to the reception apparatus 110 is not limited to the method that measures it from the transmission wave and the reflection wave, and may be realized with use of an existing method. For example, this detection may be realized with use of a distance measurement unit such as Bluetooth®, detection of a depth by a depth sensor, the Time of Flight method using infrared light, or the like. Alternatively, this detection may be realized by checking a connection of the directional communication by the non-directional communication before starting the directional communication, and acquiring position information by the communication from a position detection unit such as a GPS provided to the reception apparatus 110.

The communication control unit 205 performs an analog-to-digital conversion (ADC) and a digital-to-analog conversion (DAC). Further, the communication control unit 205 has a function of acquiring a communication quality of the reception signal such as a reception strength and a data error rate when the signal is received.

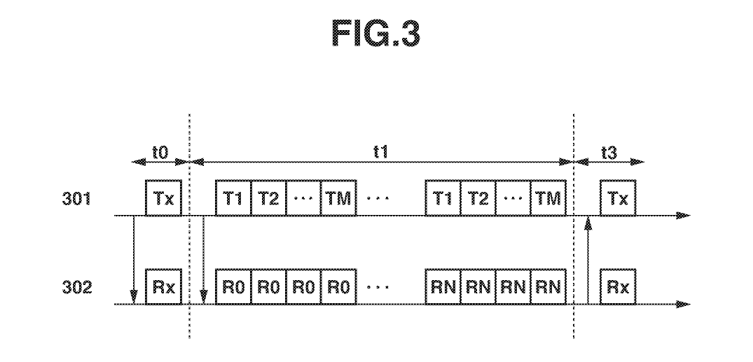

FIG. 3 is a timing chart illustrating a method for searching for the transmission direction and the reception direction (a transmission/reception direction search) that make the directional communication available between the transmission apparatus 100 and the reception apparatus 110. In FIG. 3, the transmission apparatus 100, which transmits image data, serves as a master 301, and the reception apparatus 110, which receives the image data, serves as a slave 302. In this example, combinations of the transmission direction and the reception direction are searched between the master 301 and the slave 302 in brute force approach.

The master 301 includes a directional transmission antenna capable of switching the transmission direction among M stages. In other words, the master 301 can change the number of angle steps in M manners. On the other hand, the slave 302 includes a directional reception antenna capable of switching the reception direction among N stages. In other words, the slave 302 can change the number of angle steps in N manners. The slave 302 may include a directional reception antenna having such a number of angle steps that the numbers of angle steps of the master 301 and the slave 302 are different for each apparatus.

As illustrated in FIG. 3, upon a start of the transmission/reception direction search, first, a transmission/reception direction search condition is transmitted by a currently selected wireless communication method during a time period t0. The transmission/reception direction search condition includes information of an order in which the search is conducted. When the non-directional communication is selected, the transmission/reception direction search condition is notified of from the master 301 to the slave 302 by the non-directional communication. On the other hand, when the directional communication is selected, the transmission/reception direction search condition is transmitted from the master 301 to the slave 302 according to a currently selected transmission direction Tx and reception direction Rx.

Next, during a time period t1, the master 301 and the slave 302 search for the transmission/reception direction in which the communication is available while changing the transmission direction and the reception direction, respectively. Now, there are M×N combinations of the transmission direction and the reception direction between the master 301 and the slave 302. The slave 302 fixes the reception direction and the master 301 transmits a wireless signal while changing each transmission direction in the order determined by the transmission/reception search condition. When the master 301 completes all of the number of steps, the slave 302 changes the reception direction, and the search is repeated until the transmission and reception is completed with respect to all of the combinations. The slave 302 receives the wireless signal while changing the reception direction, and identifies the direction from which the signal arrives as the reception direction.

Next, during a time period t3, the slave 302 notifies the master 301 of a combination of the transmission direction and the reception direction (the direction from which the radio waves arrive) in which the communication has been available, with use of the non-directional communication or the transmission/reception direction of the directional communication in which the communication has been available from the beginning. Therefore, the master 301 can acquire information of the transmission/reception direction in which the communication is available.

FIGS. 4A to 4F are diagrams each illustrating an operation of the mapping processing unit 106. FIGS. 4A to 4F each illustrate a positional relationship between the transmission apparatus 100 and the reception apparatus 110. In this example, the positional relationship is illustrated while being simplified into a two-dimensional plane (x-y).

FIG. 4A is a diagram illustrating an orientation/position of the transmission apparatus 100 in the reference coordinate system at the time of a communication start of the directional communication. In the present exemplary embodiment, the orientation/position will be used as a concept including the orientation and the position. FIGS. 4B to 4F are diagrams each illustrating an individual pattern when orientations/positions of the transmission apparatus 100 and the reception apparatus 110 are changed from FIG. 4A. Each diagrams in the upper row indicates the orientation/position of the transmission apparatus 100 that is changed from an orientation/position 400 in the reference coordinate system (x-y). Each diagrams in the lower row indicates a relative position in an antenna coordinate system (a direction θ of the reception apparatus 110 as viewed from the direction in which the antenna is installed) that corresponds to the orientation/position in each reference coordinate system.

Orientations/positions 400 to 405 each indicate the orientation/position of the transmission apparatus 100 in the reference coordinate system. Positions 410, 413, 414, and 415 each indicate the position of the reception apparatus 110 in the reference coordinate system. Arrows 421, 422, 423, and 425 each indicate the change in the position or the change in the orientation, or the track of the transmission apparatus 100 in the reference coordinate system. Arrows 433 and 435 each indicate the change in the position or the track of the reception apparatus 110 in the reference coordinate system.

A position 450 indicates the position of the transmission apparatus 100 in the antenna coordinate system. Positions 460 to 464 each indicate the position of the reception apparatus 110 in the antenna coordinate system. Arrows 471 to 473 each indicate the change in the position or the track of the reception apparatus 110 in the antenna coordinate system.

The mapping processing unit 106 maps respective positions in the reference coordinate system and the antenna coordinate system, and stores these positions into the storage unit 103 as position information.

FIG. 4A illustrates the orientation/position 400 of the transmission apparatus 100 and the position 410 of the reception apparatus 110 in the reference coordinate system at the time of the communication start of the directional communication. For example, in the present exemplary embodiment, an initial orientation of the transmission apparatus 100 is a normal position and the directional antenna is installed in conformity with the normal position of the transmission apparatus 100 at the time of the communication start of the directional communication.

The control unit 102 controls the wireless communication unit 101 to conduct the transmission/reception direction search between the transmission apparatus 100 and the reception apparatus 110 to acquire the transmission/reception direction, and then acquires the distance to the reception apparatus 110 with use of the above-described distance measurement unit after that. The control unit 102 detects the position 460 of the reception apparatus 110 in the antenna coordinate system from the transmission/reception direction and the distance to the reception apparatus 110. The control unit 102 notifies the wireless communication unit 101 to set a direction toward the position 460 of the reception apparatus 110 as the transmission/reception direction of the directional communication.

The mapping processing unit 106 maps the relative position 460 between the transmission apparatus 100 and the reception apparatus 110 in the antenna coordinate system from the transmission/reception direction set to the wireless communication unit 101 (refer to the lower illustration of FIG. 4A). Further, the mapping processing unit 106 maps the position 410 of the reception apparatus 110 in the reference coordinate system from the relative position in the antenna coordinate system and the orientation/position of the transmission apparatus 100 at the time of the communication start of the directional communication (refer to the upper illustration of FIG. 4A). The mapping processing unit 106 stores the mapped positions into the storage unit 103.

In FIG. 4B, the orientation of the transmission apparatus 100 is changed due to a change 421, and the transmission apparatus 100 is changed from the orientation/position 400 to the orientation/position 401. On the other hand, the reception apparatus 110 in the reference coordinate system is not changed from the position 410. Broken lines indicate the initial orientation/position and the transmission/reception direction at the time of the communication start.

The displacement calculation unit 152 detects the change 421 of the transmission apparatus 100 in the reference coordinate system based on the detection information from the sensor 151. The mapping processing unit 106 acquires a change 471 in the relative position of the reception apparatus 110 by converting the detected change 421 in the reference coordinate system into the antenna coordinate system, and maps the change 471 from the position 460 to the position 461 of the reception apparatus 110 in the antenna coordinate system. The change 471 in the relative position of the reception apparatus 110 includes a direction and a change amount of the relative change between the transmission apparatus 100 and the reception apparatus 110.

The change in the relative position of the reception apparatus 110 in the antenna coordinate system leads to a reduction in an intensity of the signal transmitted in the direction of the reception apparatus 110. Therefore, the signal intensity can be maintained constant by the wireless communication unit 101 changing the transmission/reception direction of the directional communication according to the direction of the reception apparatus 110. The control unit 102 notifies the wireless communication unit 101 to set the direction toward the position 461 of the reception apparatus 110 in the antenna coordinate system as the transmission/reception direction of the directional communication. The directional communication is maintained by the wireless communication unit 101 changing the transmission/reception direction of the directional transmission antenna in such a manner that this direction matches the transmission/reception direction that the wireless communication unit 101 is notified of. Further, the change in the relative position of the reception apparatus 110 also leads to reductions in an intensity of the signal received and an intensity of the signal transmitted by the reception apparatus 110. Therefore, the control unit 102 of the transmission apparatus 100 transmits the information of the transmission/reception direction of the directional communication to the reception apparatus 110, by which the reception apparatus 110 changes the transmission/reception direction of the directional reception antenna to maintain the directional communication. The transmission apparatus 100 and the reception apparatus 110 may change the transmission/reception direction by transmitting and receiving the position information to and from each other.

In FIG. 4C, the position of the transmission apparatus 100 is changed due to the change 422, and the transmission apparatus 100 is changed from the orientation/position 400 to the orientation/position 402. On the other hand, the reception apparatus 110 in the reference coordinate system is not changed from the position 410. Broken lines indicate the initial orientation/position and the transmission/reception direction at the time of the communication start.

The displacement calculation unit 152 detects the change 422 of the transmission apparatus 100 in the reference coordinate system based on the detection information from the sensor 151. The mapping processing unit 106 acquires the change 472 in the relative position of the reception apparatus 110 by converting the detected change 422 in the reference coordinate system into the antenna coordinate system, and maps the change 472 from the position 460 to the position 462 of the reception apparatus 110 in the antenna coordinate system.

In FIG. 4D, the orientation/position of the transmission apparatus 100 is changed due to the change 423 and the change 424, and the transmission apparatus 100 is changed from the orientation/position 400 to the orientation/position 403. Further, the position of the reception apparatus 110 is changed due to the change 433, and the reception apparatus 110 is changed from the position 410 to the position 413. Broken lines indicate the initial orientation/position and the transmission/reception direction at the time of the communication start.

The displacement calculation unit 152 detects the changes 423 and 424 of the transmission apparatus 100 in the reference coordinate system based on the detection information from the sensor 151. Further, the mapping processing unit 106 acquires the change 433 of the reception apparatus 110 with use of a method that will be described below. The mapping processing unit 106 acquires the change 473 in the relative position of the reception apparatus 110 by converting the changes 423, 424, and 433 in the reference coordinate system into the antenna coordinate system, and maps the change 473 from the position 460 to the position 463 of the reception apparatus 110 in the antenna coordinate system.

The reception apparatus 110 can detect the change 433 by a similar method to the transmission apparatus 100, and the transmission apparatus 100 may acquire information of the change 433 from the reception apparatus 110 by the communication. Alternatively, the transmission apparatus 100 may acquire the information of the change 433 by predicting a movement direction of the reception apparatus 110 from a change amount of a communication evaluation value (evaluation information) acquired by evaluating the signal intensity or the like at the time of the communication, which will be described below. Alternatively, the transmission apparatus 100 may detect the change 433 of the reception apparatus 110 from the changes in the position and the transmission/reception direction of the transmission apparatus 100 by periodically conducting the transmission/reception direction search.

In FIG. 4E, the reference position of the transmission apparatus 100 is updated because the orientation/position of the transmission apparatus 100 is largely changed due to the changes. The reference position is updated to the orientation/position 404 of the transmission apparatus 100 and the position 414 of the reception apparatus 110 in the reference coordinate system and the position 464 of the reception apparatus 110 in the antenna coordinate system based on the orientation/position 404. The control unit 102 conducts the transmission/reception direction search and updates the reference position when the amount of the change in the transmission apparatus 100 from the initial position at the time of the communication start exceeds a predetermined threshold value. The update of the reference position is not limited to a timing at which the amount of the change in the transmission apparatus 100 exceeds the predetermined threshold value, and may be performed when the directional communication is started or ended, or when the amount of the change in the relative position between the transmission apparatus 100 and the reception apparatus 110 exceeds a predetermined threshold value.

In FIG. 4F, the orientation/position of the transmission apparatus 100 is changed due to the change 425, and the transmission apparatus 100 is changed from the orientation/position 404 to the orientation/position 405. Further, the position of the reception apparatus 110 is changed due to the change 435, and the reception apparatus 110 is changed from the position 414 to the position 415 in parallel with the transmission apparatus 100 (a parallel movement).

The displacement calculation unit 152 detects the change 425 of the transmission apparatus 100 in the reference coordinate system based on the detection information from the sensor 151. Further, the mapping processing unit 106 acquires the change 435 of the reception apparatus 110. The mapping processing unit 106 acquires absence of the relative change in the reception apparatus 110 by converting the changes 425 and 435 in the reference coordinate system into the antenna coordinate system, and keeps the position 464 of the reception apparatus 110 in the antenna coordinate system unchanged.

The control unit 102 changes the transmission/reception direction of the directional communication in such a manner that this direction matches a direction toward the relative position of the reception apparatus 110 relative to the transmission apparatus 100 that is mapped by the mapping processing unit 106 with the aim of maintaining the directional communication. Now, the relative position of the reception apparatus 110 relative to the transmission apparatus 100 can be determined from the direction and the change amount of the relative change between the transmission apparatus 100 and the reception apparatus 110. Therefore, the control unit 102 can determine the transmission/reception direction of the directional communication for maintaining the directional communication based on the direction and the change amount of the relative change between the transmission apparatus 100 and the reception apparatus 110. When predicting the movement of the reception apparatus 110, the control unit 102 predicts it from the orientation/position in the reference coordinate system. Further, when changing the transmission/reception direction of the directional communication, the control unit 102 can change the directionality width of the directional communication. In this process, the directionality width is determined based on the change amount of the relative change or a relative speed in the antenna coordinate system.

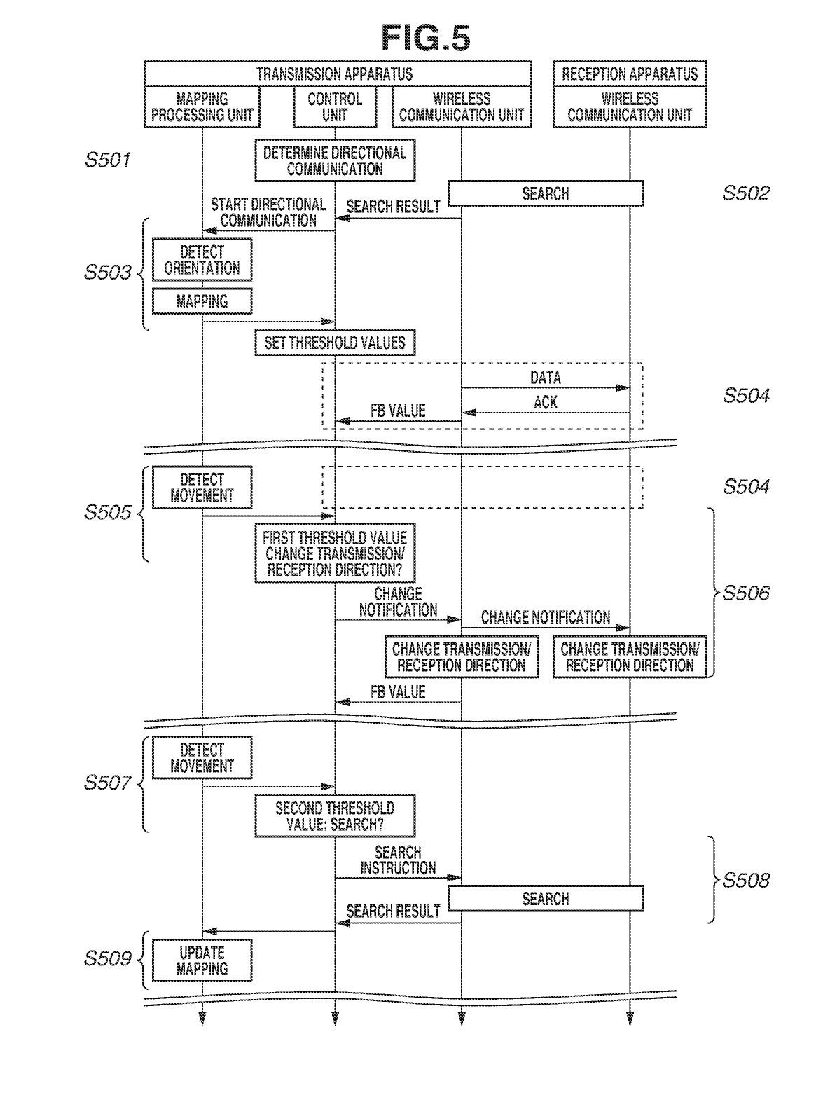

FIG. 5 is a sequence diagram illustrating an example of processing when the transmission apparatus 100 changes the transmission/reception direction, and is realized by the control unit 102 executing the program stored in the storage unit 103. In the sequence diagram illustrated in FIG. 5, the processing is started when the user selects execution of the wireless communication between the transmission apparatus 100 and the reception apparatus 110.

In step S501, the control unit 102 of the transmission apparatus 100 determines whether the directional communication (the millimeter-wave communication) has been performed between the transmission apparatus 100 and the reception apparatus 110 before. In a case where the directional communication has been performed before, the processing proceeds to step S502. On the other hand, in a case where the directional communication has not been performed before, the control unit 102 attempts a wireless connection with the reception apparatus 110 by a predetermined authentication method with use of the non-directional communication based on, for example, WiFi®. Upon completion of establishment of the wireless connection by the non-directional communication, the control unit 102 determines whether the reception apparatus 110 to which the transmission apparatus 100 is connected supports the directional communication using, for example, a carrier frequency of 60 GHz. In a case where the reception apparatus 110 supports the directional communication, the processing proceeds to step S502.

In step S502, the control unit 102 of the transmission apparatus 100 conducts the transmission/reception direction search by controlling the wireless communication unit 101, to check the transmission/reception direction between the transmission apparatus 100 and the reception apparatus 110. More specifically, the control unit 102 searches in brute force approach for the combination of the transmission direction and the reception direction that makes the directional communication available by the transmission/reception direction search illustrated in FIG. 3. The control unit 102 receives a search result from the reception apparatus 110, and determines a transmission/reception direction having a highest communication evaluation value and also determines the directionality width to employ when performing the directional communication with use of the determined transmission/reception direction. The control unit 102 determines the directionality width based on, for example, the communication evaluation value. Further, the control unit 102 detects the distance to the reception apparatus 110 with use of the distance measurement unit. The control unit 102 stores the determined transmission/reception direction and the distance to the reception apparatus 110 into the storage unit 113. The control unit 102 notifies the wireless communication unit 101 and the reception apparatus 110 of the determined transmission/reception direction. Further, the control unit 102 notifies the displacement detection unit 105 and the mapping processing unit 106 of the start of the directional communication. At this time, the notification includes the information of the transmission/reception direction of the directional communication and the distance to the reception apparatus 110.

In step S503, the sensor 151 of the displacement detection unit 105 starts detecting the orientation/position of the transmission apparatus 100 at the time of the communication start. Further, the mapping processing unit 106 maps the relative position of the reception apparatus 110 in the antenna coordinate system from the determined transmission/reception direction of the directional communication and the distance to the reception apparatus 110. Subsequently, the mapping processing unit 106 maps the positions of the transmission apparatus 100 and the reception apparatus 110 in the reference coordinate system based on the current orientation/position detected by the sensor 151. The mapping processing unit 106 stores the mapped positions into the storage unit 103. Further, the control unit 102 sets threshold values (a first threshold value and a second threshold value) to refer to when changing the transmission/reception direction and when proceeding to the transmission/reception direction search.

In step S504, the control unit 102 of the transmission apparatus 100 notifies the reception apparatus 110 of the transmission/reception direction via the wireless communication unit 101 and starts the data transmission by the directional communication by controlling the wireless communication unit 101. More specifically, the control unit 102 of the transmission apparatus 100 transmits image data (data) via the wireless communication unit 101, and the reception apparatus 110 transmits a reception completion (an acknowledgment (ACK)) to the transmission apparatus 100 in response to receipt of the image data. The control unit 102 receives a feedback (FB) value as the communication evaluation value of the communication quality that is included in information of the reception completion. The FB value is such a value that the signal intensity, a signal-to-noise (SN) value, or the like when the reception apparatus 110 receives, for example, a control packet included in the transmission signal is fed back to the transmission apparatus 100. The transmission of the image data is repeated until the directional communication is ended.

In step S505, the mapping processing unit 106 detects the change in the relative position of the reception apparatus 110. More specifically, the sensor 151 detects the change in the transmission apparatus 100, by which the displacement calculation unit 152 detects the change in the transmission apparatus 100 in the reference coordinate system based on the detection information from the sensor 151. The mapping processing unit 106 acquires the change in the relative position of the reception apparatus 110 by converting the change in the reference coordinate system into the antenna coordinate system.

In step S506, the control unit 102 determines whether the amount of the relative change exceeds the first threshold value based on the change in the relative position of the reception apparatus 110 that has been acquired by the mapping processing unit 106. The first threshold value is a threshold value for determining whether to change the transmission/reception direction, and is set based on, for example, the directionality width.

In a case where the amount of the relative change exceeds the first threshold value, the control unit 102 notifies the wireless communication unit 101 of the change in the transmission/reception direction. Further, the control unit 102 notifies the reception apparatus 110 of the change in the transmission/reception direction of the directional communication by controlling the wireless communication unit 101. The notification of the change in the transmission/reception direction includes the information of the transmission/reception direction for maintaining the directional communication. The control unit 102 calculates the transmission/reception direction for maintaining the directional communication from the mapped relative position between the transmission apparatus 100 and the reception apparatus 110. The control unit 102 changes the transmission/reception direction of the directional communication with the notification of the change serving as a trigger thereof. Further, the reception apparatus 110 changes the transmission/reception direction of the directional communication to the transmission/reception direction that the reception apparatus 110 has been notified of. The control unit 102 may receive the FB value after changing the transmission/reception direction.

The first threshold value is not limited to being the threshold value compared with the amount of the relative change. For example, the control unit 102 may calculate the distance between the transmission/reception direction kept in the current state and the reception apparatus 110 from the positions mapped by the mapping processing unit 106 after the transmission apparatus 100 is changed, and change the transmission/reception direction in a case where they are spaced apart from each other by a predetermined distance (a first predetermined distance) or longer. Alternatively, for example, the control unit 102 may change the transmission/reception direction in a case where the communication evaluation value of the directional communication with the reception apparatus 110 falls below a predetermined threshold value (a first predetermined value). In this case, the transmission apparatus 100 can use the communication evaluation value, such as the signal intensity and the SN value, included in the reception completion received from the reception apparatus 110. In this process, partial data in the control packet can be used as data for the evaluation of the signal to prevent the communication evaluation value from being changed due to, for example, the change in the directionality width. A signal intensity when the notification of the reception completion is received from the reception apparatus 110 may be used as the communication evaluation value. Alternatively, for example, the control unit 102 may change the transmission/reception direction if the amount of the change from the initial orientation/position in the reference coordinate system is a predetermined amount (a first predetermined amount) or larger.

In step S507, the mapping processing unit 106 detects the change in the relative position of the reception apparatus 110. This processing is similar to the processing in step S505.

In step S508, the control unit 102 determines whether the amount of the relative change exceeds the second threshold value based on the change in the relative position of the reception apparatus 110 that has been acquired by the mapping processing unit 106. The second threshold value is a threshold value for determining whether to conduct the transmission/reception direction search, and is set based on, for example, the directionality width. The first threshold value and the second threshold value are set to such values that the amount of the relative change exceeds the first threshold value before exceeding the second threshold value, when gradually increasing.

The second threshold value is not limited to being the threshold value compared with the amount of the relative change. For example, the control unit 102 may be configured to conduct the transmission/reception direction search in a case where the transmission/reception direction kept in the current state and the reception apparatus 110 are spaced apart from each other by a predetermined distance (a second predetermined distance) or longer therebetween after the transmission apparatus 100 is changed, similarly to the first threshold value. Alternatively, for example, the control unit 102 may be configured to conduct the transmission/reception direction search in a case where the communication evaluation value of the directional communication with the reception apparatus 110 falls below a predetermined threshold value (a second predetermined value), similarly to the first threshold value. Alternatively, for example, the control unit 102 may be configured to conduct the transmission/reception direction search in a case where the amount of the change from the initial orientation/position in the reference coordinate system is a predetermined amount (a second predetermined amount) or larger, similarly to the first threshold value. Alternatively, for example, the control unit 102 may be configured to conduct the transmission/reception direction search in a case where the reception completion (the ACK) is not returned from the reception apparatus 110 within a predetermined time period. Alternatively, for example, the control unit 102 may use, for example, a cumulative time of the change detected by the displacement detection unit 105.

When being unable to acquire the information of the change in the reception apparatus 110 from the reception apparatus 110, the control unit 102 can conduct the transmission/reception direction search by predicting the change in the reception apparatus 110 from the change in the signal intensity.

In a case where the amount of the change in the reception apparatus 110 exceeds the second threshold value, the control unit 102 conducts the transmission/reception direction search by controlling the wireless communication unit 101. The control unit 102 receives the search result from the reception apparatus 110, and determines to use the transmission/reception direction having the highest communication evaluation value as the transmission/reception direction of the directional communication. The control unit 102 notifies the wireless communication unit 101 and the reception apparatus 110 of the determined transmission/reception direction. Further, the control unit 102 notifies the mapping processing unit 106 of the information of the determined transmission/reception direction.

In step S509, the mapping processing unit 106 updates the relative position of the reception apparatus 110 in the antenna coordinate system based on the received transmission/reception direction of the directional communication.

Next, a method by which the mapping processing unit 106 updates the position based on the search result of the transmission/reception direction search will be described.

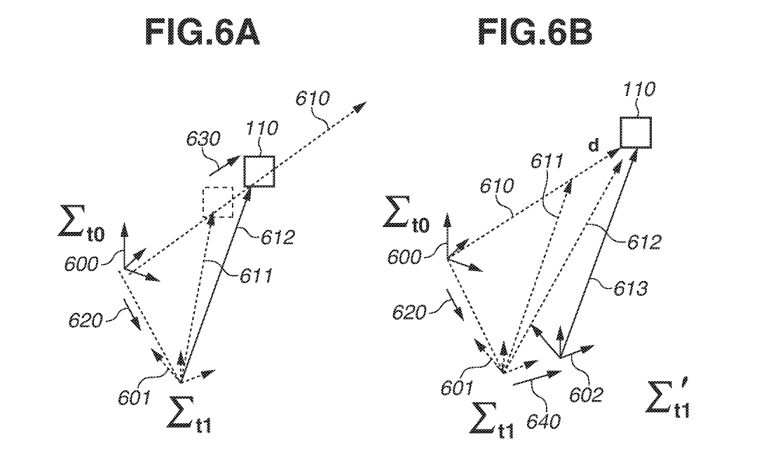

FIG. 6A is a diagram illustrating processing in which the mapping processing unit 106 updates the position of the reception apparatus 110 by the transmission/reception direction search. In the present exemplary embodiment, Σt0 and Σt1 represent an initial orientation/position 600 and an orientation/position 601 of the transmission apparatus 100 at time t1 in the reference coordinate system, respectively. As a result of conducting the transmission/reception direction search at Σt0, the position of the reception apparatus 110 is detected to be a transmission direction 610.

After the transmission apparatus 100 is moved due to a change 620, the mapping processing unit 106 calculates that the transmission apparatus 100 is located at the orientation/position Σt1 at time t1 based on the information of the change detected by the displacement detection unit 105. Further, the mapping processing unit 106 calculates the direction in which the reception apparatus 110 is located in the antenna coordinate system after the movement to the orientation/position Σt1 at time t1 from a geometrical relationship based on the mapped position. A direction 611 is a direction of the reception apparatus 110 from the orientation/position al that the mapping processing unit 106 predicts based on the result detected by the displacement detection unit 105.

The control unit 102 detects that the position of the reception apparatus 110 is a transmission/reception direction 612 having the highest communication evaluation value after conducting the transmission/reception direction search at the orientation/position Σt1.

The mapping processing unit 106 can calculate the position of the reception apparatus 110 from the transmission direction 610 at the initial orientation/position Σt0 and the transmission/reception direction 612 after the transmission/reception direction search at the orientation/position Σt1. The mapping processing unit 106 updates the mapped position stored in the storage unit 103 by reflecting the calculated position of the reception apparatus 110.

In this manner, the relative position of the reception apparatus 110 can be detected by repeating the transmission/reception direction search according to the change in the transmission apparatus 100. In a case where the displacement detection unit 105 functions with high detection accuracy, a change 630 in the reception apparatus 110 in the reference coordinate system can be detected.

FIG. 6B is a diagram illustrating processing in which the mapping processing unit 106 updates the position of the reception apparatus 110 by the transmission/reception direction search in a case where the displacement detection unit 105 functions with low detection accuracy. In this example, as a result of conducting the transmission/reception direction search at the initial orientation/position Σt0, the reception apparatus 110 is located in the transmission direction 610 and at a distance d from the transmission apparatus 100.

After the transmission apparatus 100 is moved due to the change 620, the mapping processing unit 106 calculates that the transmission apparatus 100 is located at the orientation/position Σt1 at time t1 based on the information of the change detected by the displacement detection unit 105. Further, the mapping processing unit 106 predicts that the position of the reception apparatus 110 corresponding to the orientation/position Σt1 would be located in the direction 611. At this time, the mapping processing unit 106 conducts the transmission/reception direction search at the orientation/position al because the change 620 of the transmission apparatus 100 exceeds the predetermined amount in the reference coordinate system.

As a result of conducting the transmission/reception direction search at the orientation/position Σt1, the reception apparatus 110 is determined to be located in the direction 611 and at the distance d in the antenna coordinate system.

When a mismatch occurs between the result of the mapping by the mapping processing unit 106 and the search result of the transmission/reception direction search, the mapping processing unit 106 calculates the position of the transmission apparatus 100 based on the geometrical relationship from the position of the reception apparatus 110 that is detected by the transmission/reception direction search. The mapping processing unit 106 calculates that the reception apparatus 110 is located in a transmission/reception direction 613 from an orientation/position Σt1′ in the reference coordinate system from a relationship between the direction 611 and the distance d in the antenna coordinate system, and updates the mapped position stored in the storage unit 103.

In this manner, according to the present exemplary embodiment, the control unit 102 performs control to change the transmission/reception direction (a communication direction) for performing the directional communication between the transmission apparatus 100 and the reception apparatus 110 based on the change in the position of the transmission apparatus 100. Therefore, the directional communication can be maintained even when the position of the transmission apparatus 100 is changed, and therefore the stabilization of the directional communication can be achieved. In this manner, by maintaining the directional communication, it is possible to reduce a frequency at which the transmission/reception direction is searched for (sought) and therefore possible to secure a band where the communication is performed.

Further, according to the present exemplary embodiment, the control unit 102 performs control to change the communication direction for performing the directional communication between the transmission apparatus 100 and the reception apparatus 110 based on the change in the orientation and the change in the position of the transmission apparatus 100. Therefore, the directional communication can be maintained even when the position and the orientation of the transmission apparatus 100 are changed simultaneously, and therefore the stabilization of the directional communication can be achieved.

In the above-described exemplary embodiment, in the case where the sensor 151 is the acceleration sensor or the like, the accuracy of detecting the change in the transmission apparatus 100 may undesirably reduce due to an accumulated integration error, depending on a reciprocating motion of the transmission apparatus 100 or a detection time. In this case, the mapping processing unit 106 can update the mapped position stored in the storage unit 103 by reflecting the position of the reception apparatus 110 from the search result of the transmission/reception direction search. The distance from the transmission apparatus 100 to the reception apparatus 110 is not limited to being detected with use of the distance measurement unit, and this distance may be detected by another method.

A second exemplary embodiment will be described regarding an operation of changing the directionality width of the directional communication according to the change in the transmission apparatus 100. The configurations of the transmission apparatus 100 and the reception apparatus 110 are similar to the first exemplary embodiment.

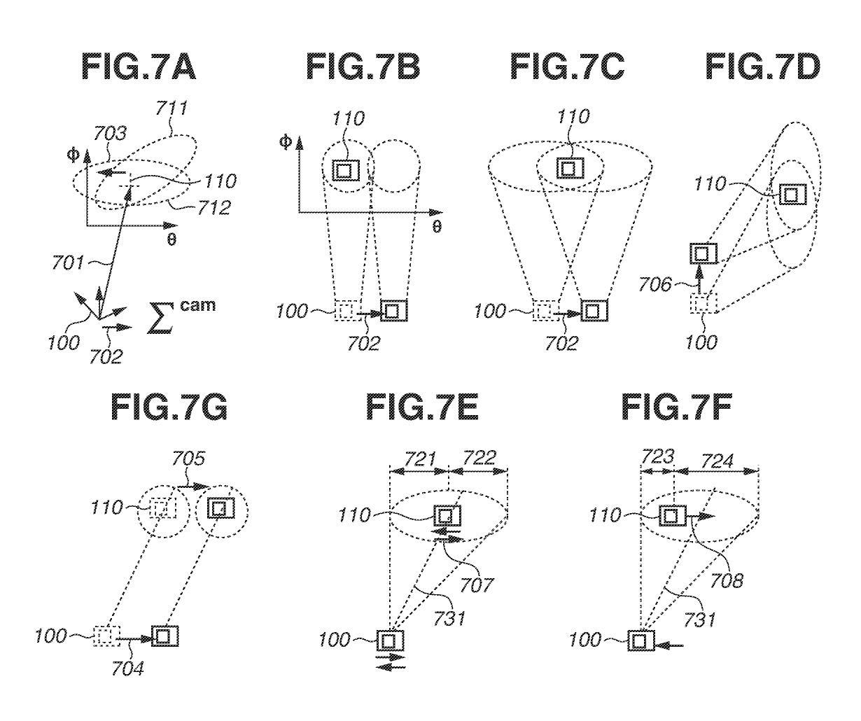

FIG. 7A is a conceptual diagram illustrating the transmission direction and the directionality width of the directional transmission antenna with respect to the orientation/position of the transmission apparatus 100. In the following description with reference to FIGS. 7A to 7G, the change in the position is taken as a movement and the amount of the change in the position is taken as a movement amount. In this example, the control unit 102 controls the transmission direction of the directional transmission antenna in such a manner that this direction is oriented in a direction 701 in the antenna coordinate system. Broken lines 711 and 712 each indicate a range where the communication strength can be maintained at a level at which the communication is possible.

Next, assume that the transmission apparatus 100 is moved in a direction 702 as illustrated in FIG. 7A. When the transmission apparatus 100 is moved in the direction 702, the displacement detection unit 105 detects the change in the reference coordinate system. This movement is equivalent to the movement in which the reception apparatus 110 relatively moves in a direction 703 opposite from the movement direction of the transmission apparatus 100 in the antenna coordinate system. If the reception apparatus 110 is moved in the direction 703 with the transmission apparatus 100 fixed, the relative movement of the reception apparatus 110 in the antenna coordinate system is detected by acquiring the information of the change in the reception apparatus 110 from the reception apparatus 110. The control unit 102 determines the transmission/reception direction for maintaining the directional communication based on the direction and the change amount of the relative change in the reception apparatus 110 in the antenna coordinate system that are calculated by the mapping processing unit 106.

In examples of the present exemplary embodiment, the transmission apparatus 100 and the reception apparatus 110 share a common reference point, and the changes in the transmission apparatus 100 and the reception apparatus 110 are detectable. The antennas of the transmission apparatus 100 and the reception apparatus 110 face each other at the time of the communication start of the directional communication, which allows them to be placed in the same reference coordinate system from the detected direction and distance.

In a case where the movement of the transmission apparatus 100 is detected, the control unit 102 controls the wireless communication unit 101 to change the transmission direction of the directional transmission antenna to an opposite direction from the detected movement direction. Alternatively, in a case where the reception apparatus 110 is moved, the control unit 102 controls the wireless communication unit 101 to change the transmission direction of the directional transmission antenna to the same direction as the movement direction of the reception apparatus 110.

Further alternatively, in a case where the transmission apparatus 100 and the reception apparatus 110 are moved simultaneously, the control unit 102 converts the detected movement amounts (change amounts) into values according to a scale in the three-dimensional space where they are mapped, and controls the transmission direction of the directional transmission antenna according to a summed vector amount. For example, as illustrated in FIG. 7G, when the transmission apparatus 100 and the reception apparatus 110 are moved in the same direction by equal movement amounts 704 and 705, the relative position thereof is unchanged, so that the control unit 102 does not change the transmission direction of the directional transmission antenna.

FIG. 7B illustrates an example when the transmission apparatus 100 is moved in the direction 702 and the reception apparatus 110 is not moved. If the transmission signal has a narrow directionality width, the communication strength is kept high, and thus, stable communication can be performed. On the other hand, in a case where the transmission signal has a narrow directionality width, the directional communication is unintentionally ended when the transmission direction departs from the communication range of the reception apparatus 110 due to the movement of the transmission apparatus 100. In this case, the transmission apparatus 100 loses track of the relative positional relationship of the reception apparatus 110, which raises a necessity of conducting the transmission/reception direction search.

FIG. 7C illustrates an example when the directionality width of the transmission signal is changed due to the movement of the transmission apparatus 100 in the direction 702. The mapping processing unit 106 detects the relative movement of the transmission apparatus 100 relative to the reception apparatus 110, by which the control unit 102 controls the wireless communication unit 101 to increase the directionality width of the transmission signal along the movement direction, i.e., along the direction in which the relative position is changed. Increasing the directionality width in this manner allows the communication to be performed over a further wide range against the movement of the transmission apparatus 100. However, increasing the directionality width undesirably leads to deterioration of the communication sensitivity and a reduction in the communication distance, so that it is desirable to increase the directionality width within a needed minimum range.

FIG. 7D illustrates an example when the directionality width of the transmission signal is changed due to a movement of the transmission apparatus 100 in a direction 706, which is a vertical direction. The mapping processing unit 106 detects the relative movement of the transmission apparatus 100 relative to the reception apparatus 110, by which the control unit 102 controls the wireless communication unit 101 to increase the directionality width of the transmission signal along the direction 706, which is the vertical direction, i.e., along the direction in which the relative position is changed.

FIG. 7E illustrates an example when the directionality width of the transmission signal is changed due to a movement of the reception apparatus 110. In this example, the reception apparatus 110 is repeatedly horizontally moved along a direction 707. The control unit 102 controls the wireless communication unit 101 in such a manner that the reception apparatus 110 is located at a substantially central position of the directionality width of the transmission signal. Therefore, a left-side width 721 and a right-side width 722 of the directionality width of the transmission signal extend over substantially equal distances from the reception apparatus 110.

FIG. 7F illustrates an example when the directionality width of the transmission signal is changed according to a predicted movement direction of the reception apparatus 110. In this example, the reception apparatus 110 is moved to the right along a direction 708. In a case where the movement direction can be predicted, the control unit 102 controls the wireless communication unit 101 to shift the center of the directionality width of the transmission signal to add a margin to the movement direction. Therefore, a right-side width 724, which is a movement direction side, extends by a distance longer than a left-side width 723 of the directionality width of the transmission signal from the reception apparatus 110. In a case where the relative movement direction of the reception apparatus 110 cannot be predicted, the control unit 102 can prevent the reception apparatus 110 from departing the communication range by controlling the wireless communication unit 101 in such a manner that the reception apparatus 110 is located at the substantially central position of the directionality width of the transmission signal.

The above-described examples are not limited to when the transmission apparatus 100 is moved, and the directionality width can also be changed according to the change in a similar manner even when the orientation of the transmission apparatus 100 is changed or when the orientation and the position of the transmission apparatus 100 are changed.

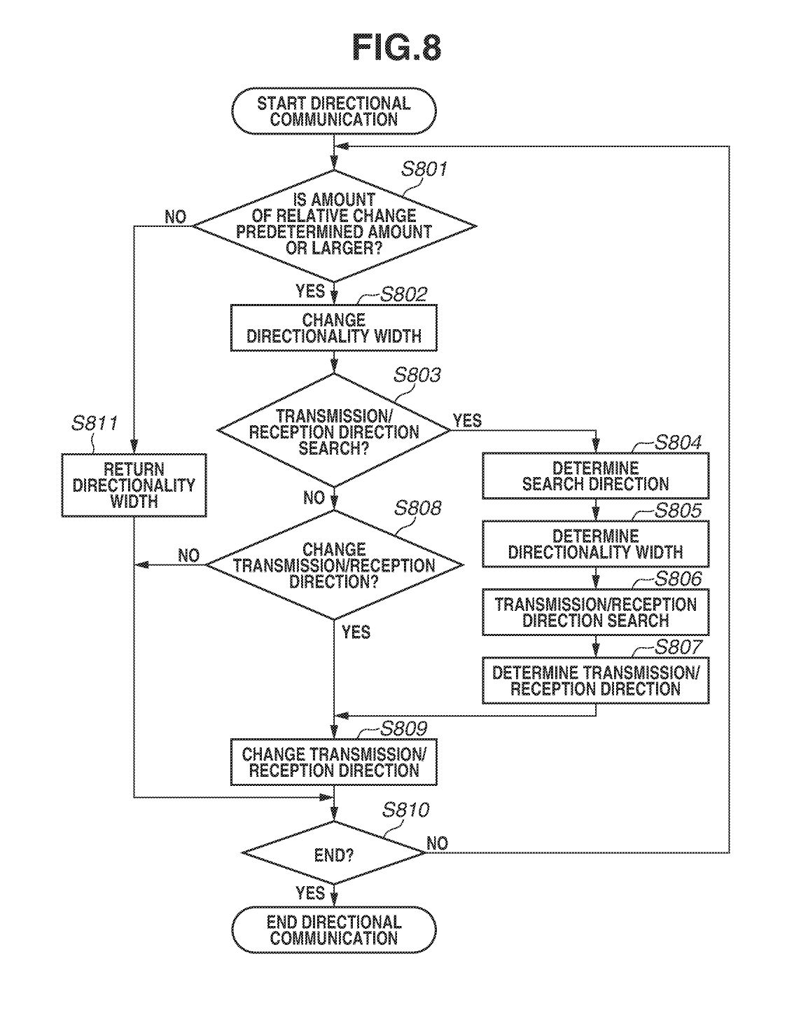

FIG. 8 is a flowchart illustrating an example of processing when the transmission apparatus 100 changes the directionality width, and is realized by the control unit 102 executing the program stored in the storage unit 103. A start of the flowchart illustrated in FIG. 8 is triggered by a start of the directional communication between the transmission apparatus 100 and the reception apparatus 110. In this processing, the transmission/reception direction search is conducted, and the mapping processing unit 106 maps the positions of the transmission apparatus 100 and the reception apparatus 110 and stores them into the storage unit 103.

In step S801, the mapping processing unit 106 calculates the amount of the change in the relative position between the transmission apparatus 100 and the reception apparatus 110 when at least any one of the transmission apparatus 100 and the reception apparatus 110 is changed. The control unit 102 determines whether the calculated change amount is a predetermined amount or larger. In a case where the calculated change amount is not the predetermined amount or larger (NO in step S801), the processing proceeds to step S811, in which the control unit 102 continues the communication while maintaining the transmission/reception direction and the directionality width used at the time of the communication start. On the other hand, in a case where the calculated change amount is the predetermined amount or larger (YES in step S801), the processing proceeds to step S802.

In step S802, the control unit 102 controls the wireless communication unit 101 to increase the directionality width of the transmission signal along the direction of the change in the relative position between the transmission apparatus 100 and the reception apparatus 110. In this process, the control unit 102 increases the directionality width according to the amount of the change in the relative position between the transmission apparatus 100 and the reception apparatus 110 that has been calculated by the mapping processing unit 106. In other words, the control unit 102 performs control in such a manner that the directionality width increases as the change amount increases and reduces as the change amount reduces. This control is not limited to changing the directionality width according to the change amount, and the control unit 102 may be configured to increase the directionality width according to the relative speed between the transmission apparatus 100 and the reception apparatus 110. In other words, the control unit 102 performs control in such a manner that the directionality width increases as the relative speed increases and reduces as the relative speed reduces.

For example, when the orientation is changed in such a manner that the transmission apparatus 100 is rotationally moved, the speed more likely increases than when the position is changed in such a manner that the transmission apparatus 100 is translated, so that the directionality width of the transmission signal increases.

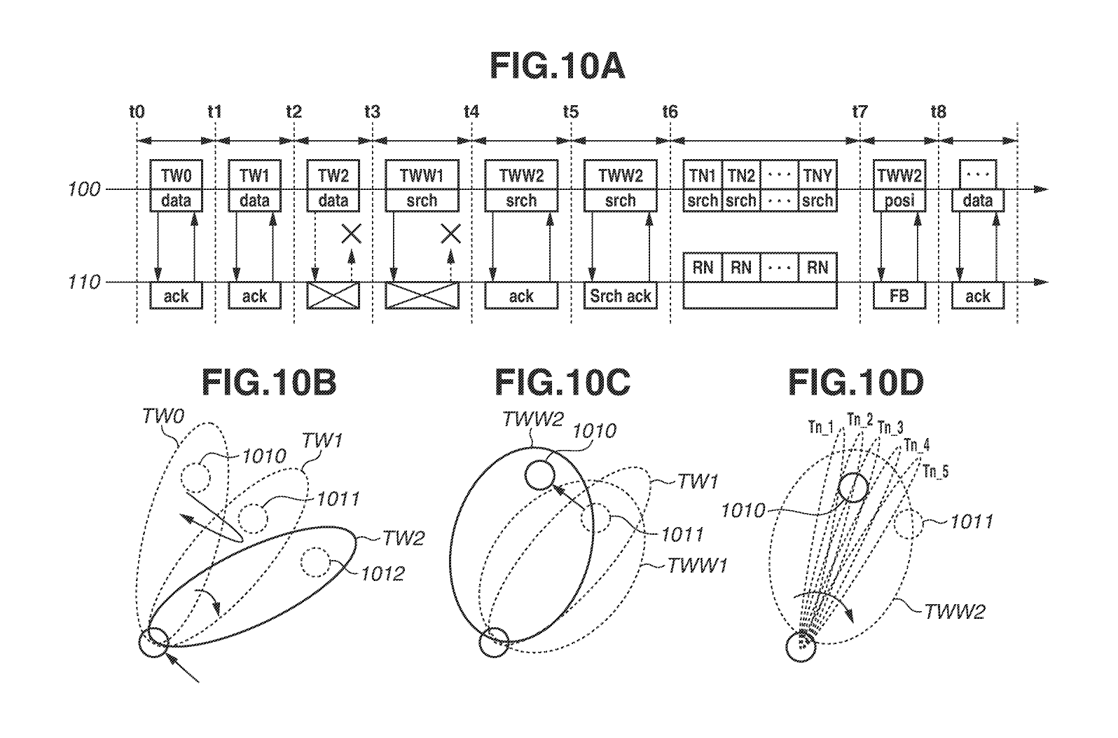

In step S803, the control unit 102 determines whether to conduct the transmission/reception direction search. For example, in a case where the amount of the change in the relative position between the transmission apparatus 100 and the reception apparatus 110 that has been calculated by the mapping processing unit 106 exceeds a threshold value, the control unit 102 determines to conduct the transmission/reception direction search (YES in step S803). The threshold value is, for example, a value larger than the predetermined amount used in the determination in step S801, and the second threshold value described above in the first exemplary embodiment can be used. Alternatively, the control unit 102 may determine whether to conduct the transmission/reception direction search by a method that will be described below with reference to FIGS. 10A to 10D. In a case where the control unit 102 conducts the transmission/reception direction search (YES in step S803), the processing proceeds to step S804. In a case where the control unit 102 does not conduct the transmission/reception direction search (NO in step S803), the processing proceeds to step S808.

In step S804, the control unit 102 determines the search direction and range based on the amount and the direction of the change in the relative position between the transmission apparatus 100 and the reception apparatus 110 that have been calculated by the mapping processing unit 106. For example, the control unit 102 performs control in such a manner that the range of the search increases as the change amount increases and reduces as the change amount reduces.

In step S805, the control unit 102 determines the directionality width of the transmission signal in the transmission/reception direction search.

In step S806, the control unit 102 conducts the transmission/reception direction search by controlling the wireless communication unit 101 based on the determined directionality width. In this process, the control unit 102 conducts the transmission/reception direction search only in the determined search direction and within the determined search range.

In step S807, the control unit 102 determines to use the transmission/reception direction having the highest communication evaluation value as the transmission/reception direction of the directional communication based on the search result. The mapping processing unit 106 updates the relative position of the reception apparatus 110 in the antenna coordinate system based on the determined transmission/reception direction, and stores the updated relative position into the storage unit 103. Further, the control unit 102 updates the storage unit 103 in such a manner that the transmission/reception direction of the directional communication is stored as the determined transmission/reception direction.

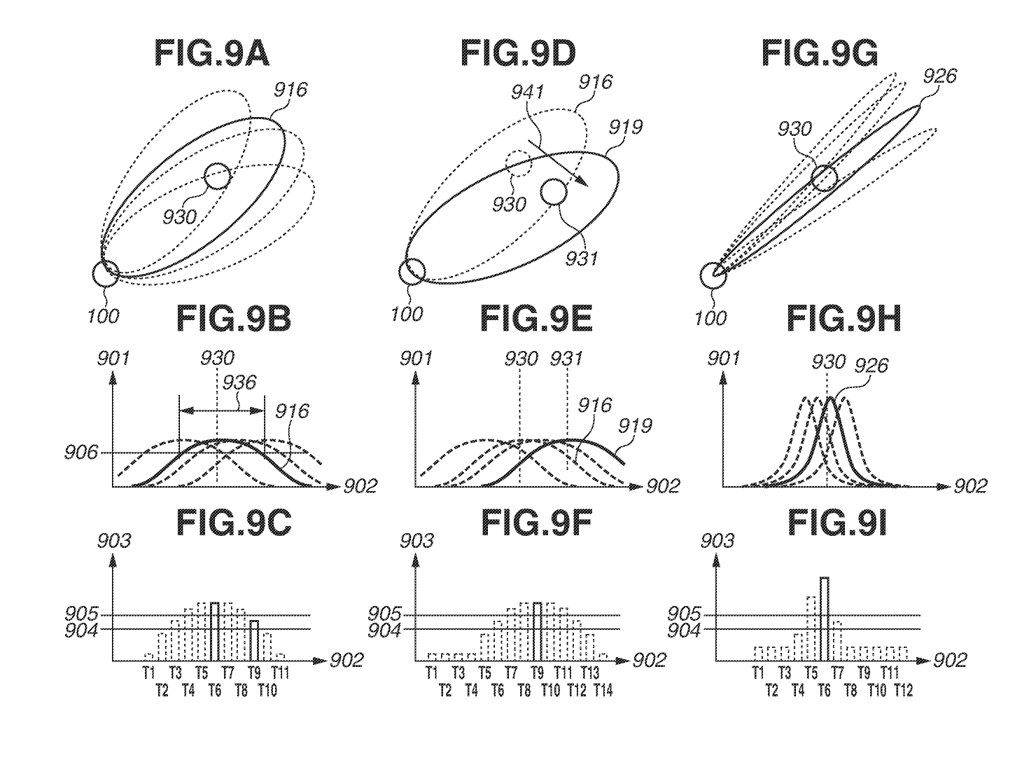

On the other hand, in step S808, the control unit 102 determines whether to change the transmission/reception direction. For example, in a case where the amount of the change in the relative position between the transmission apparatus 100 and the reception apparatus 110 that has been calculated by the mapping processing unit 106 exceeds a threshold value, the control unit 102 determines to change the transmission/reception direction (YES in step S808). The threshold value is, for example, a value larger than the predetermined amount used in the determination in step S801, and the first threshold value described above in the first exemplary embodiment can be used. Alternatively, the control unit 102 may determine whether to change the transmission/reception direction by a method that will be described below with reference to FIGS. 9A to 9I. In a case where the control unit 102 changes the transmission/reception direction (YES in step S808), the processing proceeds to step S809. In a case where the control unit 102 does not change the transmission/reception direction (NO in step S808), the processing proceeds to step S810.

In step S809, the control unit 102 changes the transmission/reception direction of the directional communication. In this process, in the case where the processing proceeds from step S807 to step S809, the control unit 102 controls the wireless communication unit 101 in such a manner that the transmission/reception direction of the directional communication is set to the transmission/reception direction updated and stored in the storage unit 103. On the other hand, in the case where the processing proceeds from step S808 to step S809, the control unit 102 calculates the transmission/reception direction for maintaining the directional communication from the mapped relative position between the transmission apparatus 100 and the reception apparatus 110, and changes the transmission/reception direction to the calculated transmission/reception direction of the directional communication.

In step S810, the control unit 102 determines whether to end the directional communication. In a case where the directional communication is completed or the end thereof is selected by the user, the control unit 102 ends the directional communication (YES in step S810). On the other hand, in a case where the control unit 102 does not end the directional communication (NO in step S810), the processing returns to step S801, from which the above-described processing is repeated. In a case where the control unit 102 determines that the calculated change amount is not the predetermined amount or larger in step S801 (NO in step S801), the processing proceeds to step S811.

In step S811, the control unit 102 returns the directionality width of the transmission signal to the directionality width at the time of the communication start, and then continues the communication. In other words, the control unit 102 returns and reduces the directionality width according to disappearance of the relative change between the transmission apparatus 100 and the reception apparatus 110. In this process, the control unit 102 may conduct the transmission/reception direction search again and check the relative position between the transmission apparatus 100 and the reception apparatus 110. The control unit 102 can enhance the signal intensity of the transmission signal by reducing the directionality width when the relative position is not changed. Further, the control unit 102 can minimize interference of the reception signal by reducing the directionality width. Therefore, the communication speed can be increased and the stabilization of the directional communication can also be achieved. In step S811, the control unit 102 may reduce the directionality width according to a reduction in the relative speed between the transmission apparatus 100 and the reception apparatus 110 and increase the directionality width according to an increase in the relative speed therebetween.

In the above description, step S802 has been described referring to the example in which the control unit 102 increases the directionality width according to the amount of the change in the relative position or the relative speed, but is not limited to this example. The control unit 102 may change the directionality width according to the distance to the reception apparatus 110. Because a directionality range increases with respect to a transmission angle at the position of the reception apparatus 110 as the distance to the reception apparatus 110 increases, the control unit 102 reduces the directionality width as the distance increases. On the other hand, the control unit 102 increases the directionality width as the distance to the reception apparatus 110 reduces.

Further, the transmission/reception direction search in the above-described step S803 and the change in the transmission/reception direction in the above-described step S808 have been described referring to the example in which the control unit 102 determines whether the amount of the change in the relative position between the transmission apparatus 100 and the reception apparatus 110 exceeds the threshold value, but are not limited to this example. For example, the control unit 102 may determine whether the change amount when the transmission apparatus 100 is changed from the initial orientation, a cumulative time during which the transmission apparatus 100 is changed from the initial orientation, or a cumulative time of the relative change between the transmission apparatus 100 and the reception apparatus 110 exceeds a threshold value. In this case, if the employed parameter exceeds the threshold value, the processing proceeds to step S804 or step S809. Alternatively, for example, the control unit 102 may determine whether the communication evaluation value falls below a predetermined value. In this case, if the communication evaluation value falls below the predetermined value, the processing proceeds to step S804 or step S809. Further alternatively, for example, the control unit 102 may determine whether the reception completion (the ACK) is received from the reception apparatus 110 within a predetermined time period. In this case, if the reception completion cannot be received within the predetermined time period, the processing proceeds to step S804 or step S809.

FIGS. 9A to 9I are diagrams illustrating the control when the transmission/reception direction of the directional communication is changed or the directionality width is changed.

FIGS. 9A, 9D, and 9G each illustrate the relative position between the transmission apparatus 100 and the reception apparatus 110.

FIGS. 9B, 9E, and 9H are graphs each indicating the signal intensity of the transmission signal with respect to the transmission direction. A vertical axis 901 represents the signal intensity of the transmission signal, and a horizontal axis 902 represents a signal angle of the transmission direction.

FIGS. 9C, 9F, and 9I are graphs each indicating the signal intensity of the reception signal with respect to the transmission direction. A vertical axis 903 represents the signal intensity of the reception signal of the reception apparatus 110 that is used as the communication evaluation value. A horizontal axis 902 indicates the signal angle of the transmission direction.

The transmission apparatus 100 conducts the transmission/reception direction search, and acquires the signal intensity of the reception signal of the reception apparatus 110 from the reception apparatus 110 by the communication. The intensity of the reception signal during the data communication by the directional communication can be acquired from the reception apparatus 110 together with communication data. Further, the signal intensity used in this process is not limited to the signal intensity of the reception signal that is received from the reception apparatus 110, and the signal intensity when the notification of the reception completion is received from the reception apparatus 110 during the data communication may be used as another communication evaluation value.

FIG. 9A illustrates the relative position between the transmission apparatus 100 and the reception apparatus 110 when the transmission signal has a wide directionality width. The transmission apparatus 100 transmits a transmission signal 916 to the reception apparatus 110 located at a relative position 930.

FIG. 9B is a graph indicating a change in a signal intensity of the transmission signal 916 with respect to the transmission direction. A position 930 indicated by a dotted line represents the relative position of the reception apparatus 110 as viewed from the transmission apparatus 100. A threshold value 906 is a signal intensity predicted by the transmission apparatus 100 at which the communication is possible. A directionality range 936 is a range where the signal intensity predicted by the transmission apparatus 100 at which the communication is possible can be acquired with respect to the transmission signal 916. The control unit 102 can calculate the directionality range where a predetermined or higher signal intensity can be acquired from the search result of the transmission/reception direction search. The control unit 102 may determine the threshold value of the directionality range to refer to when changing the transmission/reception direction, based on an amount of control of the directionality range set to the wireless communication unit 101. FIG. 9C is a graph indicating a relationship of the signal intensity for each transmission signal received by the reception apparatus 110 at the position 930. A threshold value 904 is a threshold value of a signal intensity at which stable communication is possible. In this example, a range of a transmission direction T3 to a transmission direction T9 is determined to be the range in which the communication is possible. A threshold value 905 is a threshold value of the signal intensity needed when the transmission/reception direction is changed.

FIG. 9D illustrates the relative position between the transmission apparatus 100 and the reception apparatus 110 when the reception apparatus 110 is moved from the position 930 to a position 931. The transmission apparatus 100 changes the transmission direction from the transmission signal 916 to a transmission signal 919.

FIG. 9E is a graph indicating a change in a signal intensity of the transmission signal 919 with respect to the transmission direction. Dotted lines 930 and 931 each represent the relative position of the reception apparatus 110 as viewed from the transmission apparatus 100.

FIG. 9F is a graph indicating a relationship of the signal intensity for each transmission signal received by the reception apparatus 110 at the position 931. In FIG. 9C, when the reception apparatus 110 is moved from the position 930 to the position 931 with the transmission signal 916 transmitted, the signal intensity of the reception apparatus 110 according to the transmission signal 916 is changed from a signal intensity corresponding to a transmission direction T6 to a signal intensity corresponding to a transmission direction T9. Therefore, the control unit 102 determines that the transmission/reception direction should be changed because the signal intensity falls below the threshold value 905. The control unit 102 changes the transmission direction as indicated by the transmission signal 919 by controlling the wireless communication unit 101, by which the reception apparatus 110 is positioned at a center of a directionality range of the transmission signal 919, so that the signal intensity with respect to the transmission signal 919 illustrated in FIG. 9F reaches or exceeds the threshold value 905.

In this manner, in the above-described step S808 in the flowchart illustrated in FIG. 8, the control unit 102 can determine whether to change the transmission/reception direction based on whether the signal intensity received from the reception apparatus 110 exceeds the threshold value. The signal intensity is changed according to the transmission/reception direction of the directional communication set by the transmission apparatus 100, so that the control unit 102 determines the threshold value of the signal intensity based on the transmission/reception direction. However, whether to change the transmission/reception direction can be determined based on whether the reception apparatus 110 exceeds the threshold value of the directionality range 936. If the relative position of the reception apparatus 110 geometrically exceeds the preset threshold value of the directionality range 936, the control unit 102 can determine that the transmission/reception direction should be changed.

FIG. 9G illustrates the relative position between the transmission apparatus 100 and the reception apparatus 110 when the transmission signal has a narrow directionality width. The transmission apparatus 100 transmits a transmission signal 926 to the reception apparatus 110 located at the relative position 930.

FIG. 9H is a graph indicating a change in a signal intensity of the transmission signal 926 with respect to the transmission direction.

FIG. 9I is a graph indicating a relationship of the signal intensity for each transmission signal received by the reception apparatus 110 at the position 930. If the transmission signal has a narrow directionality width, the transmission direction T6 is determined to be the direction of the reception apparatus 110. On the other hand, if the transmission signal has a wide directionality width, the reception apparatus 110 is determined to be located within a range of any of a transmission direction T4 to a transmission direction T8 as illustrated in FIG. 9C. The direction of the reception apparatus 110 can be detected with improved accuracy by conducting the search while reducing the directionality width.

In a case where the control unit 102 determines to conduct the transmission/reception direction search in the above-described step S803 (YES in step S803), the control unit 102 controls the wireless communication unit 101 in such a manner that the directionality width of the transmission signal falls below the directionality width of the current transmission signal. Because it is clear that the reception apparatus 110 is located within the directionality range of the currently selected transmission direction, the control unit 102 divides the directionality range of the currently selected transmission direction into further narrower directionality widths, and conducts the search therein. For example, the control unit 102 conducts the search through n steps while targeting directionality widths acquired by dividing the inside of the directionality range into n widths. Alternatively, the control unit 102 may determine the search range to cover the directionality width of the currently selected transmission direction with use of a minimum directionality width needed for the position detection. Alternatively, the control unit 102 may narrow down the search range by predicting the position of the reception apparatus 110 from the communication evaluation value received from the reception apparatus 110. As the number of steps of the transmission/reception direction search reduces, a time period taken until the data communication is restarted can be shortened.

FIGS. 10A to 10D are diagrams illustrating the transmission/reception direction search when the reception apparatus 110 departs from the directionality range.

FIG. 10A illustrates a timing chart when the data communication is performed between the transmission apparatus 100 and the reception apparatus 110. FIG. 10B illustrates relative positions between the transmission signal from the transmission apparatus 100 and the reception apparatus 110 from time t0 to time t3. FIG. 10C illustrates relative positions between the transmission signal from the transmission apparatus 100 and the reception apparatus 110 from time t3 to time t5. FIG. 10D illustrates relative positions between the transmission signal from the transmission apparatus 100 and the reception apparatus 110 from time t5 to time t7.

During times t0 and t1, the control unit 102 of the transmission apparatus 100 performs the data communication via a transmission signal TW0 having a wide directionality width while detecting the relative change between the transmission apparatus 100 and the reception apparatus 110 by the mapping processing unit 106. The transmission signal TW0 is a signal having a directionality width W in a transmission direction T0.

During time t0 to time t3 illustrated in FIG. 10A, the position of the reception apparatus 110 is relatively changed to a position 1010 at time t0, a position 1011 at time t1, and the position 1010 again at time t2 as viewed from the transmission apparatus 100, as illustrated in FIG. 10B. The transmission apparatus 100 changes the transmission direction according to the change in the relative position of the reception apparatus 110. Then, during time t0 to time t3, the transmission direction is changed as indicated by the transmission signal TW0 at time t0, a transmission signal TW1 at time t1, and a transmission signal TW2 at time t2 as viewed from the transmission apparatus 100.

At time t2, the reception apparatus 110 departs from the transmission signal TW2, so that the transmission apparatus 100 cannot transmit the transmission data to the reception apparatus 110 or receive the notification of the reception completion from the reception apparatus 110.

At time t3, the control unit 102 determines that the reception apparatus 110 departs from the directionality range of the transmission signal. The control unit 102 can determine that the reception apparatus 110 departs from the directionality range, for example, when the reception completion (the ACK) cannot be received within a predetermined time period set in advance, the signal intensity when the reception apparatus 110 receives the data is a predetermined value or lower, or an error rate is higher than a predetermined value. If determining that the reception apparatus 110 departs from the directionality range, the control unit 102 first returns the signal direction of the transmission signal to the most recent transmission direction in which the communication has been possible. Next, if the reception apparatus 110 is not moved, the control unit 102 conducts the transmission/reception direction search based on the position of the reception apparatus 110 immediately before the reception apparatus 110 departs from the directionality range and a vicinity thereof from the track of the change in the relative position of the reception apparatus 110 in the antenna coordinate system that is mapped by the mapping processing unit 106. On the other hand, if the reception apparatus 110 is moved, the control unit 102 predicts the position of the reception apparatus 110 from the track of the reception apparatus 110 tracked in the reference coordinate system, and conducts the transmission/reception direction search based on the predicted position. If the transmission apparatus 100 and the reception apparatus 110 are moved simultaneously, it is difficult to detect the position of the reception apparatus 110 from the track of the change in the relative position in the antenna coordinate system. Therefore, the control unit 102 determines the search direction by separately handling the respective movements thereof. More specifically, the mapping processing unit 106 maps the position of the transmission apparatus 100 and also predicts the position of the reception apparatus 110 in the reference coordinate system. The mapping processing unit 106 converts the position of the transmission apparatus 100 and the predicted position of the reception apparatus 110 into the antenna coordinate system, and notifies the control unit 102 of them. The control unit 102 conducts the transmission/reception direction search based on the position of the reception apparatus 110 that is converted into the antenna coordinate system.

At time t3, for example, the control unit 102 of the transmission apparatus 100 changes the transmission signal to a transmission signal TWW1 and determines whether the reception apparatus 110 can receive the transmission signal. Both the transmission signals TW1 and TWW1 are signals in the same transmission direction. If the communication evaluation value of the reception apparatus 110 is sufficiently high for the transmission signals TW0 to TW2 at the time of the data communication, the transmission signal may be transmitted in such a manner that the directionality width of the transmission signal TWW1>=the directionality width of the transmission signal TW1 is satisfied. Therefore, the reception apparatus 110 can receive the transmission signal in a wide directionality range. If being not notified of the reception completion from the reception apparatus 110 even after transmitting the transmission signal TWW1, the control unit 102 further transmits a transmission signal TWW2 in such a manner that the transmission direction matches a transmission direction in which the reception apparatus 110 is most likely located at time t4 based on the position mapped by the mapping processing unit 106.

At time t4, the reception apparatus 110 transmits the notification of the reception completion to the transmission apparatus 100 by receiving the transmission signal TWW2. The control unit 102 of the transmission apparatus 100 conducts the transmission/reception direction search since time t5 by receiving the notification of the reception completion.

At time t5, the transmission apparatus 100 determines to set the search direction to the transmission direction of the transmission signal TWW2 in response to which the notification of the reception completion is received, and notifies the reception apparatus 110 of the search condition including the determined search direction. Upon receiving the search condition, the reception apparatus 110 transmits a notification indicating acceptance of the search to the transmission apparatus 100.

At time t6, the control unit 102 of the transmission apparatus 100 conducts the transmission/reception direction search. More specifically, the control unit 102 conducts the transmission/reception direction search in such a manner that the transmission signal satisfies a directionality width of a transmission signal Tn<the directionality width of the transmission signal TW or the transmission signal TWW in a range of transmission directions of transmission signals Tn1 to Tnx. In this process, because being aware that the reception apparatus 110 is positioned within the range of the directionality width of the transmission signal TWW2, the control unit 102 conducts the transmission/reception direction search within the range of the directionality width of the transmission signal TWW2. For example, the control unit 102 can conduct the search through n steps while targeting directionality widths acquired by dividing the range of the directionality width of the transmission signal TWW2 into n widths. Alternatively, the control unit 102 may determine the search range in such a manner that the range of the directionality width of the transmission signal TWW2 is covered with use of the minimum directionality width needed for the position detection. Further alternatively, the control unit 102 may narrow down the search range by predicting the position of the reception apparatus 110 from the communication evaluation value received from the reception apparatus 110 at time t5. As the number of steps of the transmission/reception direction search reduces, the time period taken until the data communication is restarted can be shortened.

At time t7, the control unit 102 receives the communication evaluation value from the reception apparatus 110 as the search result. The control unit 102 transmits the transmission/reception direction having the highest communication evaluation value to the mapping processing unit 106. The mapping processing unit 106 updates the relative position between the transmission apparatus 100 and the reception apparatus 110 based on the received transmission/reception direction, and stores the updated relative position into the storage unit 103. The control unit 102 of the transmission apparatus 100 notifies the reception apparatus 110 of the transmission/reception direction having the highest communication evaluation value.

At time t8, the transmission apparatus 100 and the reception apparatus 110 restart the data communication with use of the transmission/reception direction that the transmission apparatus 100 has notified the reception apparatus 110 of.

When the transmission/reception direction search is conducted, a step width of the transmission/reception direction search may be changed according to the determined directionality width. If the directionality width is wide, the control unit 102 can reduce the number of steps of the transmission/reception direction search by increasing the step width of the transmission/reception direction search to reduce an overlap of the directionality range. On the other hand, if the directionality width is narrow, the control unit 102 can improve the accuracy of detecting the position of the reception apparatus 110 by reducing the step width of the transmission/reception direction search.

Further, when the transmission/reception direction search is conducted, the directionality width may be changed according to the distance to the reception apparatus 110. If the transmission apparatus 100 is spaced apart from the reception apparatus 110 by a long distance, the control unit 102 increases the step width with the directionality width reduced. Therefore, a wide range can be searched discretely with a small number of steps. Further, the control unit 102 can shorten a time period taken to detect the position of the reception apparatus 110 by searching a wide range to roughly estimate the position of the reception apparatus 110, and conducting the transmission/reception direction search in detail around the estimated position.

In this manner, according to the present exemplary embodiment, the control unit 102 performs control to increase the directionality width (the signal width) of the directional communication along the direction of the change in the relative position if there is a change in the relative position between the transmission apparatus 100 and the reception apparatus 110. Therefore, even when there is a change in the relative position between the transmission apparatus 100 and the reception apparatus 110, the reception apparatus 110 can be contained in the directionality range of the transmission signal, so that the directional communication can be maintained.

Further, according to the present exemplary embodiment, the control unit 102 performs control to reduce the directionality width of the directional communication when conducting the transmission/reception direction search to maintain the directional communication with the reception apparatus 110. Therefore, the position of the reception apparatus 110 can be detected with improved accuracy.

In a third exemplary embodiment, a different configuration of the transmission apparatus 100 will be described. In this exemplary embodiment, the transmission apparatus 100 is configured in such a manner that the displacement detection unit 105 according to the first exemplary embodiment is replaced with an imaging unit 1100. In the present exemplary embodiment, the imaging unit 1100 detects the change in the position and the change in the orientation of the transmission apparatus 100.

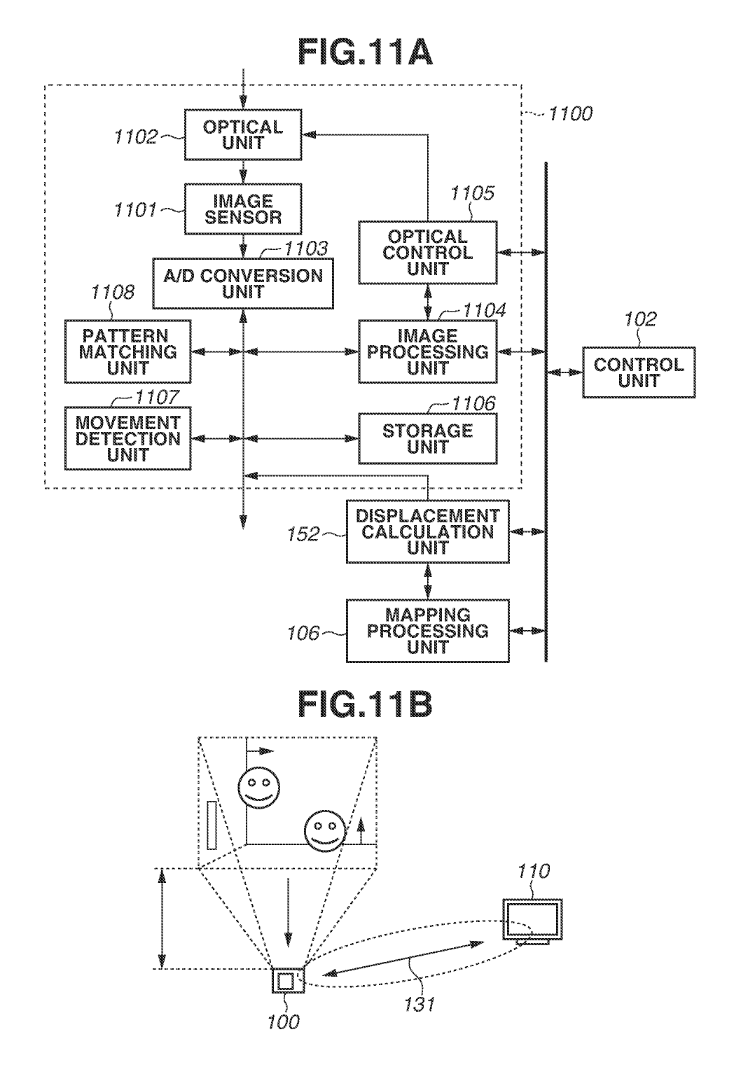

FIG. 11A is a diagram illustrating an example of a configuration of the imaging unit 1100. FIG. 11B is a diagram illustrating an example of a subject.

As illustrated in FIG. 11B, the imaging unit 1100 can acquire a captured image in which the subject is imaged. The imaging unit 1100 includes an image sensor 1101, an optical unit 1102, an A/D conversion unit 1103, an image processing unit 1104, an optical control unit 1105, a storage unit 1106, a movement detection unit 1107, a pattern matching unit 1108, and the like.

The image sensor 1101 converts a subject image formed via the optical unit 1102 into an electric signal. The image sensor 1101 is, for example, a charge coupled device (CCD) image sensor or a complementary metal-oxide semiconductor image sensor (CMOS) image sensor. The optical unit 1102 mainly includes a lens (a zoom lens, a focus lens, and the like), an actuator that drives the lens, and the like. The A/D conversion unit 1103 converts an analog signal generated by the image sensor 1101 into a digital signal. The image processing unit 1104 converts the digital signal converted by the A/D conversion unit 1103 into image data. The optical control unit 1105 controls the optical unit 1102. A surrounding condition can also be imaged by the optical control unit 1105 controlling the optical unit 1102 to a wide-angle side. The storage unit 1106 stores the image data converted by the image processing unit 1104 therein.

The movement detection unit 1107 detects a motion vector (a movement direction and a movement amount) of a moving object in a specified region in the image data stored in the storage unit 1106. The movement detection unit 1107 can identify the object in a plurality of regions, and detects the motion vector of the object for each of the regions. The pattern matching unit 1108 extracts a feature point in the image data stored in the storage unit 1106, calculates a coefficient of correlation with pattern data stored in the storage unit 1106, and extracts an arbitrary subject.

The control unit 102 captures a plurality of images corresponding to different focal lengths by the image sensor 1101 by controlling the optical control unit 1105. The control unit 102 enhances a contour by performing high-pass filter processing or the like on each of the pieces of image data, and extracts the feature point. The movement detection unit 1107 detects a change in a position of the feature point in each of the pieces of image data. The displacement calculation unit 152 can calculate the amount of the change in the transmission apparatus 100 and the like from the detected change.

Further, for example, the relative position of the reception apparatus 110 can be detected from the captured image by performing wide-angle imaging by the optical unit 1102 and detecting the reception apparatus 110 by the pattern matching unit 1108.

In this manner, according to the present exemplary embodiment, the change in the position and the change in the orientation of the transmission apparatus 100 can be detected based on the captured image captured by the imaging unit 1100. Further, the change in the position of the reception apparatus 110 can be detected based on the captured image captured by the imaging unit 1100.

The present disclosure has being described based on the representative exemplary embodiments thereof. However, the present disclosure is not limited to the above-described exemplary embodiments, and also includes various embodiments within a range that does not depart from the spirit of the present disclosure. Each of the above-described exemplary embodiments merely indicates one exemplary embodiment of the present disclosure, and each of the exemplary embodiments can also be combined with another embodiment as appropriate.

The transmission apparatus 100 is not limited to being the camera, and may be a portable electronic apparatus, such as a notebook PC, a smart-phone, or a tablet terminal.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the above-described exemplary embodiments, the stabilization of the directional communication can be achieved.

While exemplary embodiments have been described, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2017-190805, filed Sep. 29, 2017, which is hereby incorporated by reference herein in its entirety.

What is claimed is:

1. A communication apparatus that performs wireless communication by directional communication, the communication apparatus comprising:
a detection unit configured to detect a change in a position of the communication apparatus; and
a control unit configured to control changing a communication direction for performing the directional communication between the communication apparatus and another communication apparatus based on the detected change in the position of the communication apparatus.

2. The communication apparatus according to claim 1,
wherein the detection unit further detects a change in an orientation of the communication apparatus, and
wherein the control unit controls changing the communication direction for performing the directional communication between the communication apparatus and the another communication apparatus based on the detected change in the orientation and the detected change in the position of the communication apparatus.

3. The communication apparatus according to claim 1,
wherein the control unit acquires a relative position between the communication apparatus and the another communication apparatus based on the detected change in the position of the communication apparatus, and
wherein the control unit controls changing the communication direction for performing the directional communication between the communication apparatus and the another communication apparatus based on the acquired relative position between the communication apparatus and the another communication apparatus.

4. The communication apparatus according to claim 3, wherein the acquired relative position includes a change in a position of the another communication apparatus.

5. The communication apparatus according to claim 1, wherein the control unit acquires a direction and a change amount of a relative change between the communication apparatus and the another communication apparatus based on the detected change in position of the communication apparatus, and
wherein the control unit controls changing the communication direction for performing the directional communication between the communication apparatus and the another communication apparatus based on the acquired direction and the acquired change amount of the relative change.

6. The communication apparatus according to claim 1,
wherein the control unit maps a relative position of the another communication apparatus to the communication apparatus based on the detected change in position of the communication apparatus, and
wherein the control unit controls changing the communication direction for performing the directional communication between the communication apparatus and the another communication apparatus such that the communication direction for performing the directional communication matches a direction toward the mapped position of the another communication apparatus.

7. The communication apparatus according to claim 1, wherein the control unit acquires an amount of the change in the position of the communication apparatus based on the detected change in position, and, in a case where the acquired amount of the change exceeds a predetermined threshold value, controls changing the communication direction for performing the directional communication between the communication apparatus and the another communication apparatus or searching for the communication direction for performing the directional communication between the communication apparatus and the another communication apparatus.

8. The communication apparatus according to claim 7, wherein, in a case where the communication direction for performing the directional communication between the communication apparatus and the another communication apparatus is searched for, the control unit controls updating relative position information between the communication apparatus and the another communication apparatus based on the searched communication direction.

9. The communication apparatus according to claim 1, wherein the control unit acquires an amount of a relative change between the communication apparatus and the another communication apparatus based on the detected change in position of the communication apparatus, and, in a case where the acquired amount of the change exceeds a predetermined threshold value, controls changing the communication direction for performing the directional communication between the communication apparatus and the another communication apparatus or searching for the communication direction for performing the directional communication between the communication apparatus and the another communication apparatus.

10. The communication apparatus according to claim 1, wherein the control unit acquires evaluation information of the communication when the directional communication is performed between the communication apparatus and the another communication apparatus, and, in a case where the acquired evaluation information falls below a predetermined threshold value, controls changing the communication direction for performing the directional communication between the communication apparatus and the another communication apparatus or searching for the communication direction for performing the directional communication between the communication apparatus and the another communication apparatus.

11. The communication apparatus according to claim 10, wherein the control unit acquires the evaluation information of the communication when the directional communication is performed between the communication apparatus and the another communication apparatus by receiving evaluation information evaluated by the another communication apparatus or receiving and evaluating a signal transmitted from the another communication apparatus.

12. The communication apparatus according to claim 1, wherein, in a case where there is a change in a relative position between the communication apparatus and the another communication apparatus, the control unit controls increasing a signal width of the directional communication along a direction of the change in the relative position.

13. The communication apparatus according to claim 12, wherein the control unit controls increasing the signal width of the directional communication based on an amount of the change in the relative position between the communication apparatus and the another communication apparatus.

14. The communication apparatus according to claim 12, wherein the control unit controls increasing the signal width of the directional communication based on a relative speed between the communication apparatus and the another communication apparatus.

15. The communication apparatus according to claim 12, wherein, in a case where the signal width of the directional communication is changed, the control unit controls the communication direction of the directional communication such that the another communication apparatus is located at a substantially central position of the signal width.

16. The communication apparatus according to claim 1, wherein the control unit performs control such that a signal width of the directional communication is reduced as a distance to the another communication apparatus increases and the signal width of the directional communication is increased as the distance to the another communication apparatus decreases.

17. The communication apparatus according to claim 1, wherein the control unit increases a signal width of the directional communication based on a change in a relative position between the communication apparatus and the another communication apparatus, and
wherein the control unit controls reducing the signal width of the directional communication based on absence of the change in the relative position between the communication apparatus and the another communication apparatus.

18. The communication apparatus according to claim 17, wherein, in a case where searching for the communication direction for performing the directional communication between the communication apparatus and the another communication apparatus is performed while the signal width of the directional communication is increased due to the change in the relative position between the communication apparatus and the another communication apparatus, the control unit controls reducing the signal width of the directional communication.

19. The communication apparatus according to claim 17, wherein, in a case where the directional communication between the communication apparatus and the another communication apparatus cannot be performed while the signal width of the directional communication is increased due to the change in the relative position between the communication apparatus and the another communication apparatus, the control unit controls changing the communication direction to a most recent communication direction in which the directional communication was able to be performed between the communication apparatus and the another communication apparatus and increasing the signal width of the directional communication.

20. A method for controlling a communication apparatus that performs wireless communication by directional communication, the method comprising:
detecting a change in a position of the communication apparatus; and
controlling changing a communication direction for performing the directional communication between the communication apparatus and another communication apparatus based on the detected change in the position of the communication apparatus.

21. A non-transitory storage medium storing a program that when executed by a computer causes the computer to execute a method for controlling a communication apparatus that performs wireless communication by directional communication, the method comprising:
detect a change in a position of the communication apparatus; and
controlling changing a communication direction for performing the directional communication between the communication apparatus and another communication apparatus based on the detected change in the position of the communication apparatus.
